(19) United States
(12) Patent Application Publication
(10) Pub. No.: US 2016/0005536 A1
(43) Pub. Date: Jan. 7, 2016

(54) METHOD FOR MANUFACTURING A STACKED TRIANGULAR CORE TRANSFORMER

(71) Applicant: ABB TECHNOLOGY AG, Zurich (CH)

(72) Inventors: TOMASZ NOWAK, KRAKOW (PL); ROBERT PLATEK, KRAKOW (PL); WOJCIECH WYSOCKI, KRAKOW (PL); PAWEL KLYS, LODZ (PL); WOJCIECH FABIJANOWSKI, LODZ (PL); EGIL STRYKEN, DRAMMEN (NO); JOHN WALLUMROD, HOF (NO); ABDOLHAMID SHOORY, BUCHS (CH)

(21) Appl. No.: 14/768,043

(22) PCT Filed: Feb. 7, 2014
(86) PCT No.: PCT/EP2014/000354

§ 371 Date: Aug. 14, 2015

(30) Foreign Application Priority Data
Feb. 18, 2013 (EP) 13460009.7

(51) Int. Cl. H01F 41/02; H01F 41/06

(52) U.S. Cl. CPC H01F 41/0233; H01F 41/06

(57) ABSTRACT

A method for manufacturing a stacked triangular core transformer includes assembling a triangular core by positioning of two halves of one leg on an assembly stand in the horizontal position; securing the positioned halves; positioning an outer clamping beam underneath two leg halves at the one end of the leg halves; assembling a yoke segment at the one end of two halves of the core leg; and forming a first clamp of the frame. The method continues by forming a second clamp of the frame at the other end of the two halves of the core leg by repeating the above positioning, assembling and forming steps; tightening the clamps together by securing means; rotating a single core frame into vertical position and releasing securing bar of the assembly stand; assembling two additional single core frames by repeating the above steps; positioning the frames in abutting position, and tightening them together.

The present invention refers to the method for manufacturing a stacked triangular core transformer. The method is applied in a production of distribution and power transformers using a stacked technology for core transformers.

The application of triangular core concept in the design of distribution and power transformers gains the increasing interest. It is stated, that triangular core transformer requires less core material, comparing to the planar core. It also benefits by smaller footprint and fully symmetrical construction, what brings some electrical advantages. If the transformer core is done in wound technology, the level of the no-load losses is additionally lowered. However, the production of triangular core is not easy, since its design is more complex when comparing to the planar one. Because all three core columns are positioned spatially in 3D space, not in one plane, like for ordinary transformer core, the production becomes much more difficult. The specialized fabrication processes, which should be involved, require also dedicated, thus costly, tooling.

The method of making a three-phase transformer with stacked triangular core structure is known from patent application WO2005/027155. Presented method comprises the steps:
a)—cutting laminations in the shape of trapeziums with predetermined size from sheet material;
b)—stacking the said trapeziums shape laminations to form the four sides of three rectangle frames to obtain a triangular core structure with a bottom yoke, top yoke and three vertical limbs connecting the three vertices of the bottom yoke and top yoke;
c)—clamping the bottom yoke with the bottom clamps;
d)—removing the top yoke and introducing three wound coils comprising the primary and secondary windings through each vertical limbs;
e)—placing the top joke and clamping the top yoke with the top clamps and clamping the bottom clamps and top clamps by tie rods to obtain a transformer with a triangular core structure.

In the presented method the step “c” concerning clamping the bottom yoke with the bottom clamps is done after the three rectangle frames are positioned in one triangular core structure what must be performed with the usage of special tools having dedicated means for positioning of three rectangle frames in vertical position. It is impossible to hold the structure formed from three vertical rectangle frames without any special temporary protection means or any similar tool for holding the three frames made from laminations in a right position. So additional means are necessary for this aim what could be expensive and labor-absorbing.

In European Patent Application EP12182169.8 filled by applicant the method for manufacturing a stacked triangular transformer is presented. The method comprising the following steps:
a) providing three legs including stacked laminations, where each leg comprises two leg halves in a cross-sectional plane,
b) winding of a coil windings on the three legs,
c) connecting the three legs with yoke parts whereby the legs are positioned such that in the cross-sectional plane, which is perpendicular to central transformer core axis, for each leg the stacked laminations are oriented in radial direction and that each of the leg halves has a plurality of outer corners facing a corresponding leg half of a respective one of the other legs, and that for each of the halves the plurality of outer corners lie on a straight line within a lateral tolerance ΔA,
d) placing the transformer core onto a transformer tank.

In the presented patent application three legs are connected together with six yokes is such a way that each of two legs are connected one to another by two yoke segments placed at opposite ends of legs and forming a single frame. Such a frame has a clamping structure, in the form of clamping beams, which tightens together yoke segments and leg halves. The presented triangular transformer could be assembled in a typical way, using a typical tool for positioning the core of the transformer, which is clamped from one side only—in order to introduce three wound coils for each leg and then clamping the legs from the other side of the legs. Nevertheless, as such transformer has a construction which could be manufactured in the form of three independent frames having two halves of two legs and two yokes connecting the halves of these legs it is possible manufacture the stacked triangular transformer in a new way using the typical tools for assembling the parts of the transformer.

So the subject of the invention is method of manufacturing the transformer having a form presented in the patent application EP12182169.8.

The essence of the inventive method for manufacturing a stacked triangular transformer comprising a step of assembling a triangular core, releasing clamping beams and yoke segments at the top of the triangular core and taking them temporary out, positioning the coil windings on three opened core legs, assembling the top yoke segments and tightening them by top clamping beams and securing means and placing the transformer core onto a transformer tank, is that the step of assembling a triangular core comprises the following steps:
a) positioning of two halves of one leg on the base plate of the assembly stand on the horizontal position using a lower part of adapters for maintaining the proper angle between the two halves of the one leg,
b) securing the positioned halves using an upper part of adapters and the securing bar placed on steel rods,
c) positioning of an outer clamping beam underneath two leg halves at the one end of the leg halves,
d) assembling the yoke segment at the one end of two halves of the core leg, where the yoke segment is matching to the shape of the ends of the two opposite halves of the core leg,
e) positioning an inner clamping beam on a surface of the yoke segment and the two halves of the core leg and tightening both clamping beams together forming a first clamp of the frame,
f) forming a second clamp of the frame at the other end of the two halves of the core leg by repeating the steps “c” to “e”,
g) tightening the first clamp and the second clamp together by securing means,
h) rotating a single core frame into vertical position and releasing securing bar of the assembly stand, or releasing the securing bar of the assembly stand first, and next lifting a single core frame into vertical position.
i) assembling two additional single core frames, by repeating steps “a”-“h”,
j) positioning the all three single core frames in abutting position, and then tightening them mechanically at the bottom and the top of the frames.

Preferably during tightening together the outer clamping beams with the inner clamping beams, the securing screws are used.

Preferably during tightening the first clamp and the second clamp together, the clamping securing means have a form of clamping securing strips.

Alternatively during tightening mechanically the first clamp with the second clamp of a single frame, the steel rods screwed down to the opposite stiffeners are used.

Preferably during tightening mechanically all three single core frames, the frame securing screws are used.

Preferably the fixture adapters are adapted to the shape of the yoke having a form of an arc bent circularly at the angle 120°.

Alternatively the fixture adapters are adapted to the shape of the yoke bent to form a V-shape.

Preferably during the assembling three core frames into one triangular core any air gap is left between all inner clamping beams abutting themselves.

The proposed method simplifies the core assembly process, by splitting the original assembly process into three identical, but much simpler operations, in which three single frames are assembled. Finally, all three frames are fixed together, forming the complete structure of triangular core. The single frames, comprising two leg segments and two yoke segments, can be manufactured in the typical way, using standard methodology and tools, thus no special production tools are required. Moreover, assembly workers do not need to gain an experience in production of new type of transformer core, since typical steps of planar core assembly can be applied. Furthermore, this way of assembly facilities reduction of throughput time, because all three core frames may be produced simultaneously. Also the factory logistics is much simpler, since single core frames may be transported independently between assembly operations.

The present invention is depicted in an exemplary embodiment on the drawing in isometric view, where

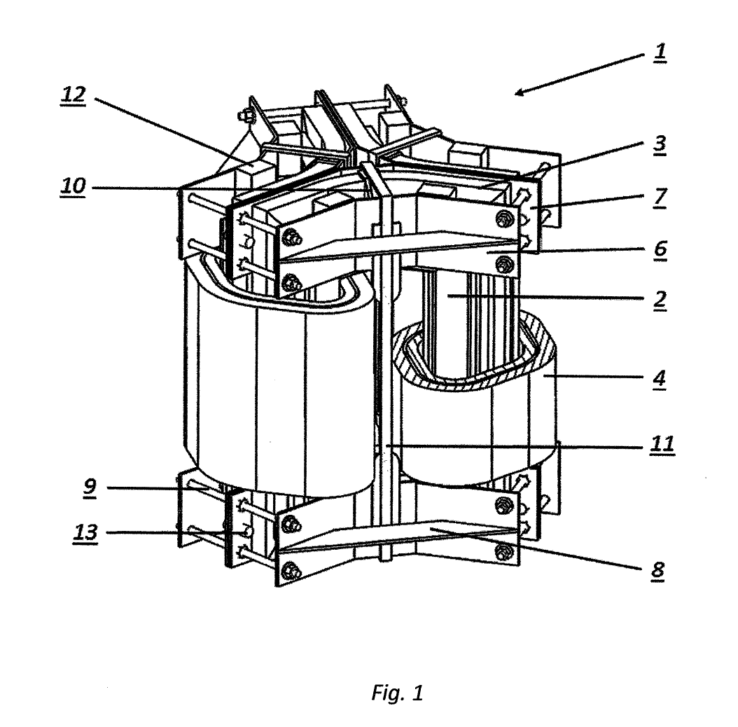

FIG. 1, presents a three-phase transformer core with coil windings, where part of windings is omitted in order to show the part of the core inside the windings,

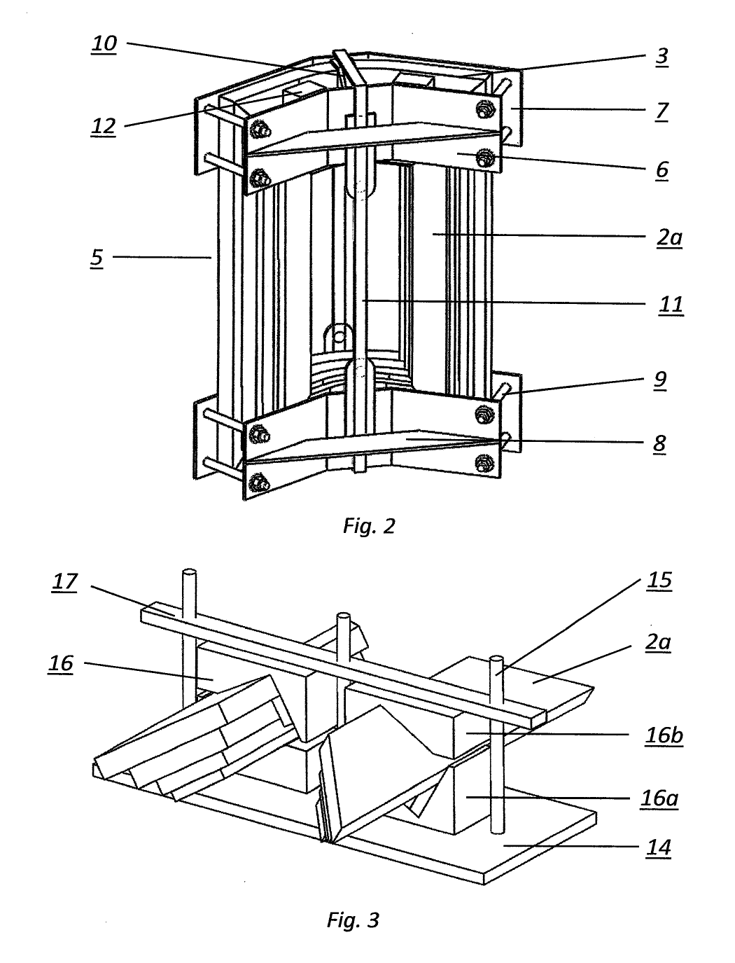

FIG. 2—a single core frame,

FIG. 3—an assembly stand with column segments of the single core frame,

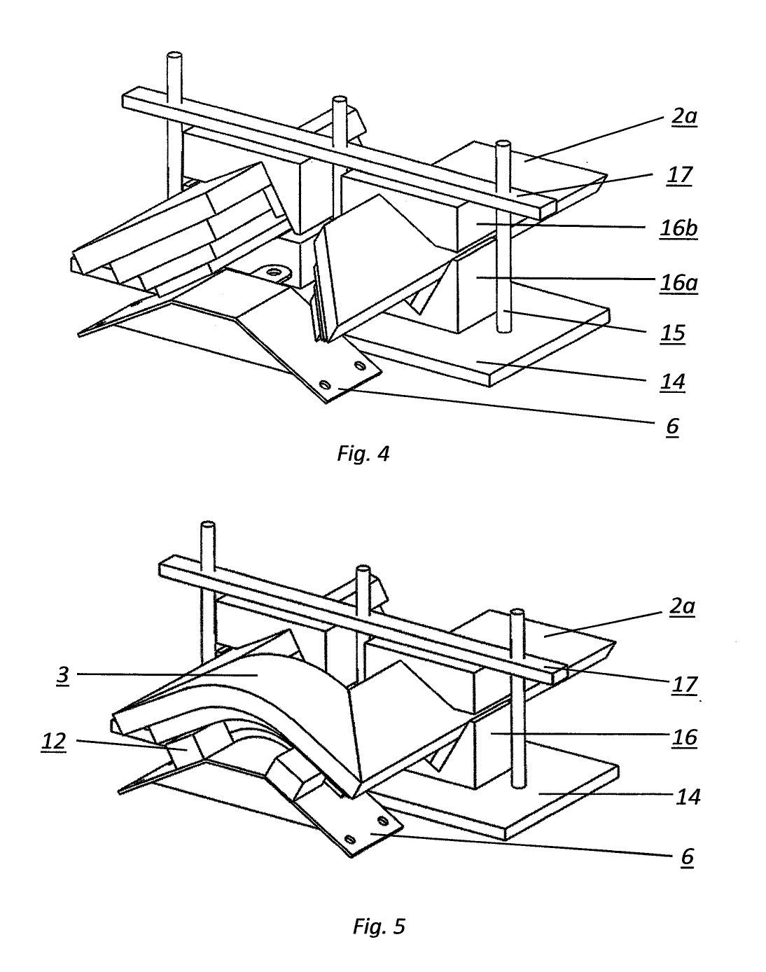

FIG. 4—an assembly stand with column segments and an outer clamping beam of the single core frame,

FIG. 5—an assembly stand with the single core frame having a yoke segment at first leg's end,

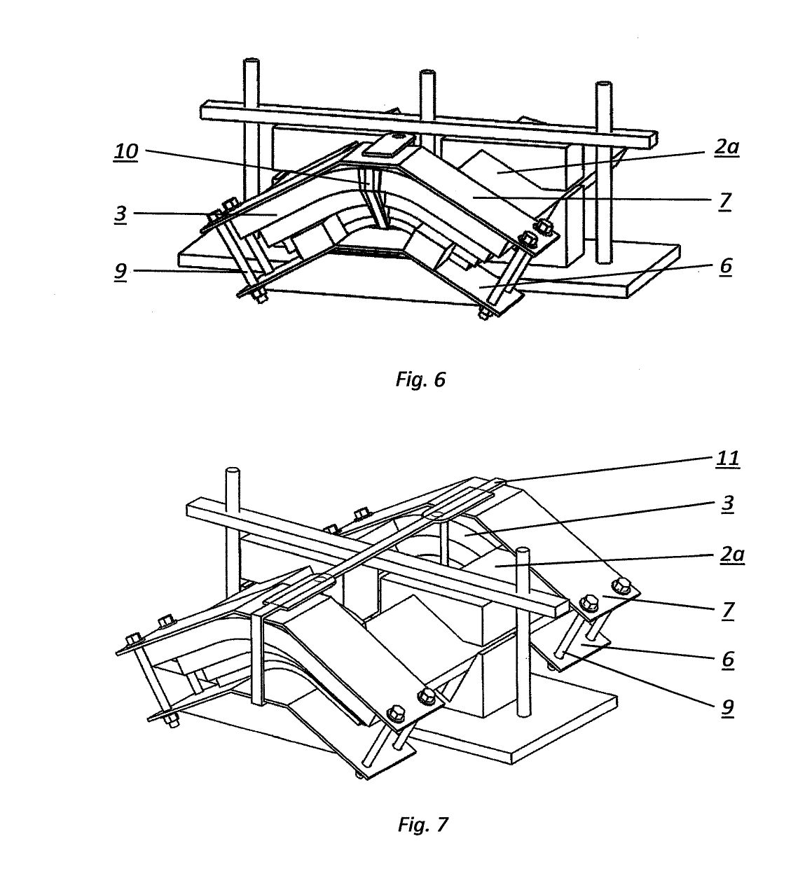

FIG. 6—an assembly stand with the single core frame with an inner clamping beam at first leg's end,

FIG. 7—an assembly stand with the single core frame with an inner clamping beam at both leg's ends.

The active part of the transformer consists of a triangular core 1 comprising three core legs 2 and six yoke segments 3, as well as three coil windings 4, which are positioned on each of the core legs. Each of the legs contains two symmetrical halves 2a, mirrored in a plane, which is perpendicular to the cross-section of the leg. A single half 2a of a given leg is connected with a single half 2a of a second leg throughout two yoke segments 3, at the top and bottom of the legs, respectively, making a single core frame 5. The yoke segment 3 has a shape of an arc bent at the angle of 120°. The yoke segment 3 can be carried out in form of a V-shape, or similar to V-shape, what is not presented on the picture. Each of the core frames is mechanically fixed by outer 6, and inner 7 clamping beams, which are placed along yoke segments 3. The outer clamping beam 6 may be equipped in, at least, one stiffener 8 having the form of flat metal sheet, or other form, not shown in the picture. Inner 7 and outer 6 clamping beams of a single core frame 5 are tightened together by securing means, preferably clamping screws 9, and/or clamping strips 10 wounded around the yoke segment 3 forming a first and a second clamp of a single core frame 5, which are placed at the two opposite ends of the frame 5, and are fixed together by frame strips 11. In other version of the core design, fixation of two opposite clamps; first and second, can be realized by steel rods screwed down to the opposite stiffeners 8, what is not presented in the drawing. In order to distribute the clamping force acting on stacked yoke segments uniformly, the stabilizing inserts 12, often having the form of wooden boxes, are provided between outer clamping beams 6 and said yoke segments 3. Three core frames form the triangular shape in the leg's cross-section plane, and they are conjoined together by dedicated securing means, preferably frame screws 13. The elements of core frame 5: legs 2 and yoke segments 3, are made of steel laminations, which are cut beforehand to trapezoidal shapes, and stacked together. The assembly process of transformer core frame is managed using the assembly stand, comprising the base plate 14 with stand rods 15, on which two fixture adapters 16 are placed, having lower part 16a and upper part 16b, designed to clamp and secure leg's halves 2a during the assembly. The shape and orientation of the fixture adapters 16 allow to keep proper angle between leg's halves within the core frame 5, which is 120°. Top parts 16b of the fixture adapter 16 are tightened by the securing bar 17, which is parallel to the external surface of the said adapter.

The method for manufacturing a stacked triangular core transformer consists on assembling the three single core frames 5 into one object having three core legs 2 and six yoke segments 3. Adding the coil windings 4 for each core leg 2 the triangular core 1 is achieved. In order to add all windings 4, the clamping beams 6 and 7 and yoke segments 3 at the top of the triangular core 1 should be released first, and taken temporary out of the transformer core 1, making the core legs opened. Second, the coil windings 4 should be positioning on the opened core legs 2 and the clamping beams and yoke segments should be placed on their previous positions. After tightening the clamping beams and yoke segments together the active part of the transformer is placed into a transformer tank not shown in the drawings.

For assembling the single core frame 5 the assembly stand, presented above in exemplary embodiment, is needed. The following steps are performed for assembling the single core frame 5.

### Step a)

Two halves of one leg 2a are positioned on the base plate 14 of the assembly stand in the horizontal position using a lower adapter 16a for maintaining the proper angle of 120° between the two halves 2a of the one leg 2.

### Step b)

The positioned halves are secured using an upper part of adapters 16b and the securing bar 17.

### Step c)

The outer clamping beam 6 is positioned underneath two leg halves 2a at the one end of the leg halves 2a (FIG. 4) using additional supporting plate, not shown in the drawing.

### Step d)

The yoke segment 3, matching to the shape of the ends of the two opposite halves 2a of the core leg, is assembled (FIG. 5).

### Step e)

The inner clamping beam 7 is positioned on a surface of the yoke segment 3 and the two halves 2a of the core leg 2 are tightened together by clamping beam 6 and 7 forming a first clamp. For the tightening of clamping beams 6 and 7 clamping securing screws 9 are used (FIG. 6).

### Step f)

The outer clamping beam 6 is positioned underneath two leg halves 2a at the second end of the leg halves 2a protruding outside the base plate 14 and steps d) to e) are repeated for the other end of the two halves of the leg, forming a second clamp (FIG. 7).

### Step g)

The first clamp and the second clamp, situated on the two ends of the two halves 2a of the leg are tightened together by securing means having a form of frame securing strips 11 and the single core frame 5 is assembled.

### Step h)

The single core frame 5 is rotated into vertical position and then securing bar 17 of the assembly stand is released. In this step the securing bar 17 of the assembly stand can be releasing first, and next a single core 5 frame is lifting into vertical position.

### Step i)

Next two additional single core frames 5 are assembled by repeating steps “a”-“h”.

### Step j)

All three single core frames 5 are positioned in such a way that in the planar view each of the inner clamping beam 7 is abutting the other two inner clamping beam 7, and then core frames are tightened mechanically by frame securing screws 13 at the bottom and the top of the frames. During the tightening three core frames 5 into one triangular core an air gap can exist between the surfaces of all inner clamping beams 7 abutting themselves, since the surfaces are not precisely adhered to each other. It is preferably that the air gap will be eliminated by tight connection.

### KEY TO THE SYMBOLS IN THE DRAWING

1—the triangular core
2—core legs
2a—core leg half
3—yoke segment
4—coil winding
5—a single core frame
6—outer clamping beam
7—inner clamping beam
8—stiffener
9—clamping securing screws
10—clamping securing strips
11—frame securing strips
12—stabilizing inserts
13—frame securing screws
14—base plate
15—stand rods
16—fixture adapters
16a—lower part of the adapter
16b—upper part of the adapter
17—securing bar

What is claimed is:

1. The method for manufacturing a stacked triangular transformer having three legs including stacked laminations, wherein a cross-sectional plane of each leg has two leg halves and having six yoke segments, making use of an assembly stand with a base plate, fixture adapters and a securing bar, where the method comprising a step of assembling a triangular core, releasing clamping beams and yoke segments at the top of the triangular core and taking them temporary out of the transformer core, positioning the coil windings on three opened core legs, assembling the top yoke segments and tightening them by top clamping beams and securing means and placing the transformer core onto a transformer tank, characterized in that the step of assembling a triangular core comprises the following steps:
a) positioning of two halves of one leg on the base plate of the assembly stand on the horizontal position using a lower part of adapters for maintain the proper angle between the two halves of the one leg,
b) securing the positioned halves using an upper part of adapters and the securing bar placed on steel rods,
c) positioning of an outer clamping beam underneath two leg halves at the one end of the leg halves,
d) assembling the yoke segment at the one end of two halves of the core leg, where the yoke segment is matching to the shape of the ends of the two opposite halves of the core leg,
e) positioning an inner clamping beam on a surface of the yoke segment and the two halves of the core leg and tightening both clamping beams and together forming a first clamp of the frame,
f) forming a second clamp of the frame at the other end of the two halves of the core leg by repeating the steps “c” to “e”,
g) tightening the first clamp and the second clamp together by securing means,
h) rotating a single core frame into vertical position and releasing securing bar of the assembly stand, or releasing the securing bar of the assembly stand first, and next lifting a single core frame into vertical position.
i) assembling two additional single core frames, by repeating steps “a”-“h”,
j) positioning the all three single core frames in abutting position, and then tightening them mechanically at the bottom and the top of the frames.

2. A method according to claim 1, characterized in that in the step e) for tightening together the outer clamping beams and the inner clamping means clamping securing screws are used.

3. A method according to claim 1, characterized in that in the step g) for tightening the first clamp and the second clamp together clamping securing means have a form of clamping securing strips.

4. A method according to claim 1, characterized in that in the step g) for tightening mechanically the first clamp with the second clamp of a single frame is realized by steel rods screwed down to the opposite stiffeners.

5. A method according to claim 1, characterized in that in the step j) for tightening mechanically all three single core frames frame securing screws are used.

6. The method according to claim 1, characterized in that in the step d) the fixture adapters is adapted to the shape of the yoke having a form of an arc bent at the angle of 120°.

7. The method according to claim 1, characterized in that in the step d) the fixture adapters is adapted to the shape of the yoke having a V-shape with the angle of 120°.

8. The method according to claim 1, characterized in that during the assembling three core frames into one triangular core in the step “f”, any air gap is left between all inner clamping beams abutting themselves.
